(19) United States
(12) Patent Application Publication
(10) Pub. No.: US 2010/0065326 A1
(43) Pub. Date: Mar. 18, 2010

(54) Cable assembly with a ring member background of the invention

(75) Inventor: David (Tso-Chin) Ko, Santa Clara, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/586,138

(22) Filed: Sep. 16, 2009

(30) Foreign Application Priority Data
Sep. 16, 2008 (CN) 200820302115.6

(51) Int. Cl. H01R 4/00

(52) U.S. Cl. 174/84 R

(57) ABSTRACT

A cable assembly (100) comprises a mating member (3), a print circuit board (2), a LED (24) attached to the print circuit board, a cable (6), a light pipe (4) having a visible area (431), an insulative shell (1), an inner cover (7), and a ring (5) located in the light pipe and neighboring to the light pipe. The cable has a positive wire (61) and a negative wire (62) connected with the mating member (3), and a strain relief portion (64) molded on the wires. A detective contact (631) is connecting with the cable. The insulative shell encloses the print circuit board, the cable and the mating member. The visible area (431) is exposed out of the insulative shell. The inner cover is over-molded on a junction between the cable and the detective contact. The ring is enclosing one of the inner cover and the strain relief portion, and the ring is lighter in color than the inner cover or the strain relief portion enclosed by the ring.

### BACKGROUND OF THE INVENTION

1. Field of the Invention

The present invention generally relates to a cable assembly, and more particularly to a cable assembly transmitting power signal.

2. Description of Related Art

Nowadays, cable assemblies are widely used in an electronic equipment, especially for transmitting power, and the performance of the cable assembly directly impacts on the entire electronic equipment whether can normally run.

A conventional cable assembly comprises a print circuit board, a LED soldered to the print circuit board to indicate the work status of the cable assembly, a light pipe receiving the LED, a cable with a plurality of wires, a plurality of contacts connected with the cable, a columnar mating member, and an insulated shell enclosing the print circuit board, the LED, the light pipe and the mating member partially. The LED may indicate working status of the cable assembly. The wires include a positive wire and a negative wire, both of them comprise an inner conductor and an insulative outer jacket respectively. The outer jackets of the positive wire and the negative wire have different colors to be distinguished. An inner cover is molded onto the electrical conjunction between one of the contacts and the wires to enhance the interconnection therebetween, and part of the wires is enclosed by the inner cover, the inner cover is made of fuscous material to avoid the outer jacket in chromatic color throwing out, such as black plastic. The cable are attached with a strain relief portion in the front thereof commonly, however the inner cover or the train relief portion may prevent the light passing therethrough, and it may be difficult for users to observe actual working status of the cable assembly.

Hence, it is desirable to have an improved structure to overcome the above-mentioned disadvantages of the prior art.

### BRIEF SUMMARY OF THE INVENTION

Accordingly, the object of the present invention is to provide a cable assembly with a ring to avoid an inner cover or a strain relief preventing the light from a LED passing through.

In order to achieve the above-mentioned object, a cable assembly in accordance with the present invention comprises a mating member, a print circuit board, a LED attached to the print circuit board, a cable, a light pipe having a visible area, an insulative shell, an inner cover, and a ring located in the light pipe and neighboring to the light pipe. The cable has a positive wire and a negative wire connected with the mating member, and a strain relief portion molded on the wires. A detective contact is connecting with the cable. The insulative shell encloses the print circuit board, the cable and the mating member. The visible area is exposed out of the insulative shell. The inner cover is over-molded on a junction between the cable and the detective contact. The ring is enclosing one of the inner cover and the strain relief portion, and the ring is lighter in color than the inner cover or the strain relief portion enclosed by the ring.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled view of a cable assembly of the first embodiment in accordance with the present invention;

FIG. 2 is an exploded view of the cable assembly of FIG. 1;

FIG. 3 is a view similar to FIG. 2, but viewed from a different angle;

FIG. 4 is a partially assembled view of FIG. 2;

FIG. 5 is another partially assembled view of FIG. 2;

FIG. 6 is a cross-section view partially of the cable assembly of FIG. 1; and

FIG. 7 is a cross-section view of the cable assembly of the second embodiment in accordance with the present invention.

### DETAILED DESCRIPTION OF THE INVENTION

Reference will now be made to the drawing figures to describe the present invention in detail.

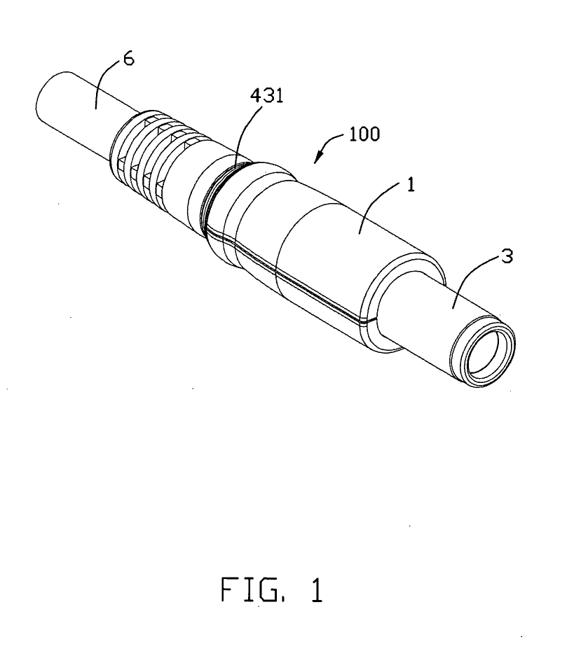

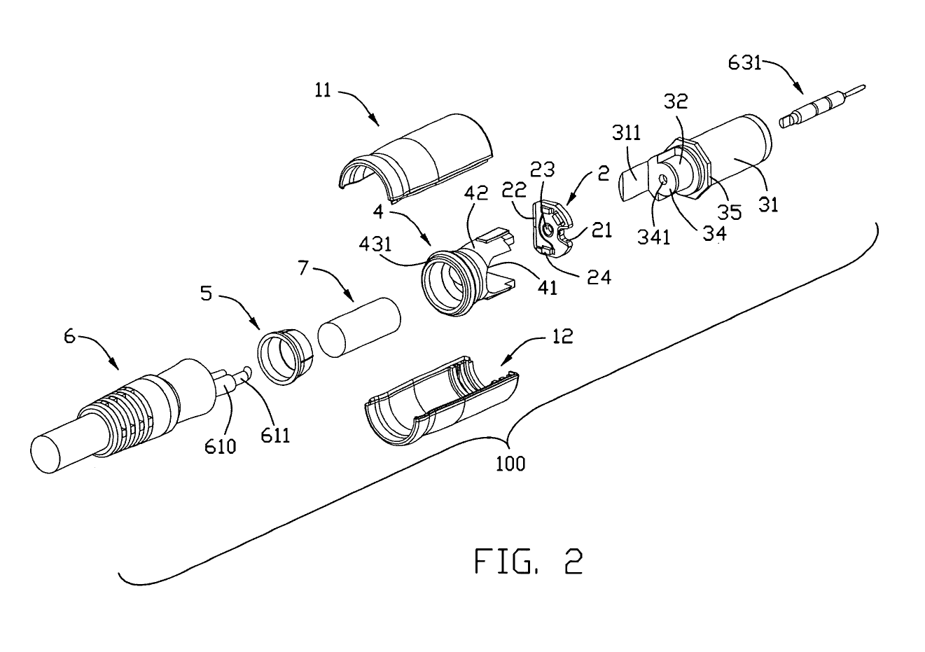

Referring to FIGS. 1-2, a cable assembly 100 made in accordance with the present invention comprises a print circuit board 2 perpendicular to a mating direction, a cylindrical mating member 3, a light pipe 4, a ring 5, a cable 6 with a plurality of wires, and an insulative shell 1 enclosing the aforementioned components.

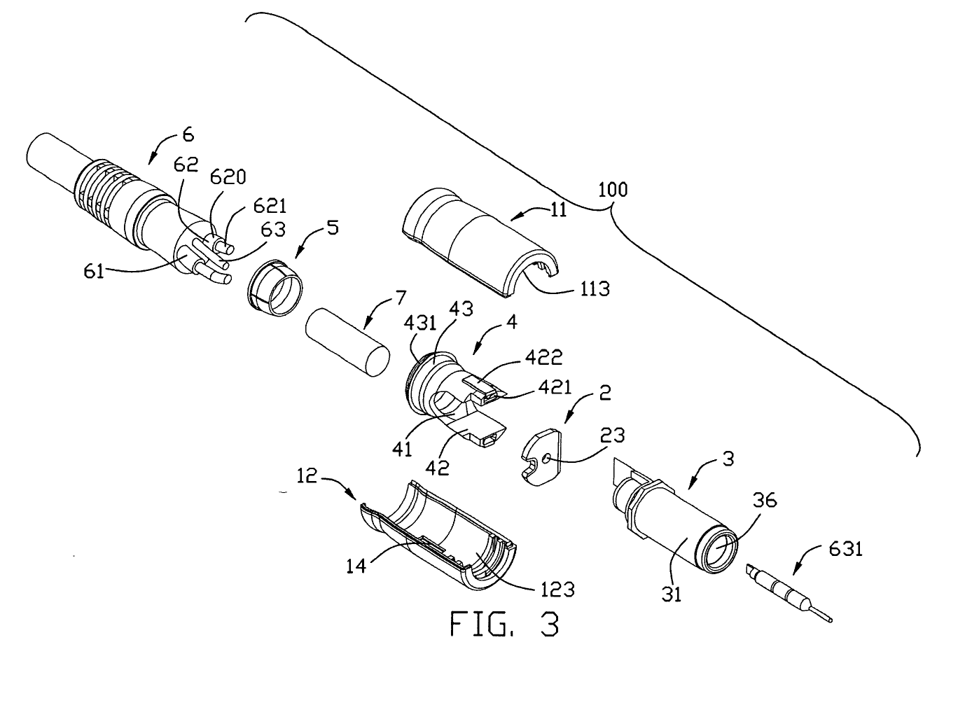

Referring to FIGS. 2-3, the insulative shell 1 has a hollowed configuration with a cylindrical shape, and is configured with a bottom shell 11 and a top shell 12. The bottom shell 11 defines a first semicircular hole 113 recessed downwards, the bottom shell 12 is symmetrical to the top shell 11 in shape, the top shell 12 has a second semicircular hole 123 together with the first semicircular hole 113 to form a circular hole. The top shell 11 and the bottom shell 12 define a rectangle groove 14 respectively.

The print circuit board 2 is arranged along a direction vertical to the mating direction, the mating member 3 and the cable 6 are located on opposite sides of the print circuit board 2. The print circuit board 2 comprises a first conductive area 21 and a second conductive area 22 disposed on opposite edges thereof, the first conductive area 21 is arranged in an aperture (not numbered), the second conductive area 22 is disposed on an upright side. The first and second conductive areas 21, 22 can be defined with other shapes in other alternative embodiments, such as a curved shape or round in shape. The print circuit board 2 also has a central hole 23 defined through a center thereof, a Light Emitting Diode (LED) 24 and a resistor (not numbered).

The cylindrical mating member 3 comprises a hollowed mating section 31 in the front end, a polygonal flange 35 surrounding the cylindrical mating member 3, and a positive tube 32 located behind the polygonal flange 35 and communicated with an inner wall 36 of the cylindrical mating member 3. The mating section 31 serves as a negative portion of the mating member 3 and is isolated from the positive tube 32 by an insulator 34. The insulator 34 defines a through hole 341 in a center axis thereof along the pluggable direction, the through hole 341 is aligning with the central hole 23 of the print circuit board 2 along the mating direction. A linking portion 311 is extending backwards from the mating section 31.

The light pipe 4 is of fork-shape and made of transparent plastic material to transmit the light from the LED 24. The light pipe 4 is also a hollowed configuration and defines two U-shaped cutouts 41 through the light pipe 4 along a direction perpendicular to the mating direction, and a pair of parallel protrusion 42 are formed on both sides of the cutouts 41. The protrusion 42 is adjacent to the LED 24 of the print circuit board 2. The light pipe 4 also has a sleeve portion 43 connecting with the protrusions 42, a visible area 431 is formed on an end of the sleeve portion 43 to indicate the status of the LED 24 for users looking at. A block member (not shown) is inserted into the light pipe 4 through the cutouts 41 to prevent the insulative material from reaching the printed circuit board 2 when a strain relief is injection molded over the cable. The protrusions 42 are vertical to the print circuit board 2 in the cable assembly 100, each protrusion 42 has a recess 421 in the surface adjacent to the print circuit board 2, and the recesses 421 are aligning with the LED 24 respectively. Each protrusion 42 defines a slick arc surface on exterior side and a slick plane on interior side, so to make the light to the protrusions 42 homogeneous. Each protrusion 42 defines a gibbous block 422 on the exterior side thereof to be received in the rectangle groove 14.

The cable 6 comprises a strain relief portion 64 for releasing stress, a positive wire 61 and a negative wire 62 extending forwardly from the strain relief portion 64, and a middle wire 63 connected to a detective contact 631 and located between the positive wire 61 and negative wire 62. The positive wire 61 and negative wire 62 respectively have outer jackets 610, 620 and inner conductors 611, 621 with part of the corresponding outer jackets 610, 620 stripped away from front end thereof.

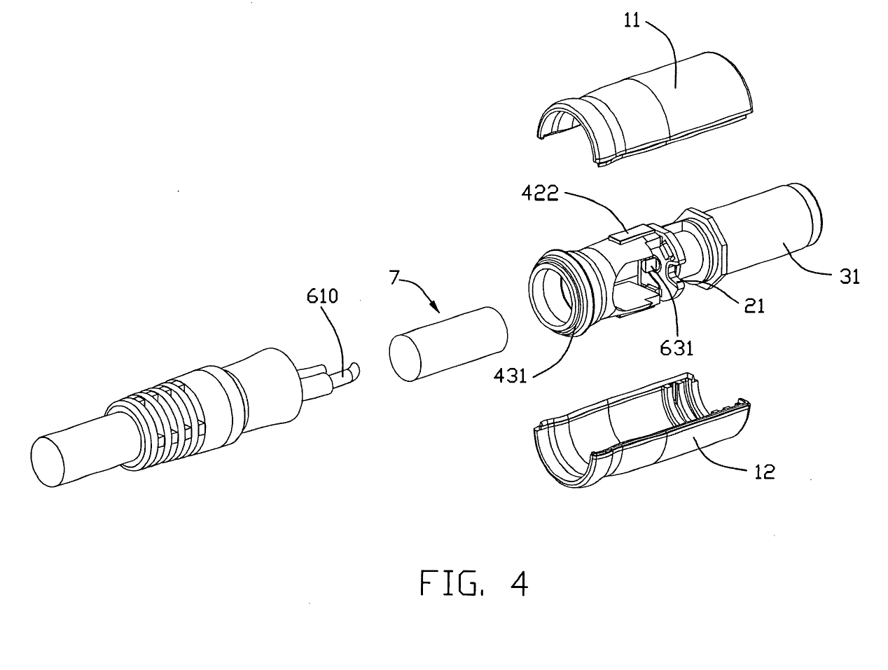

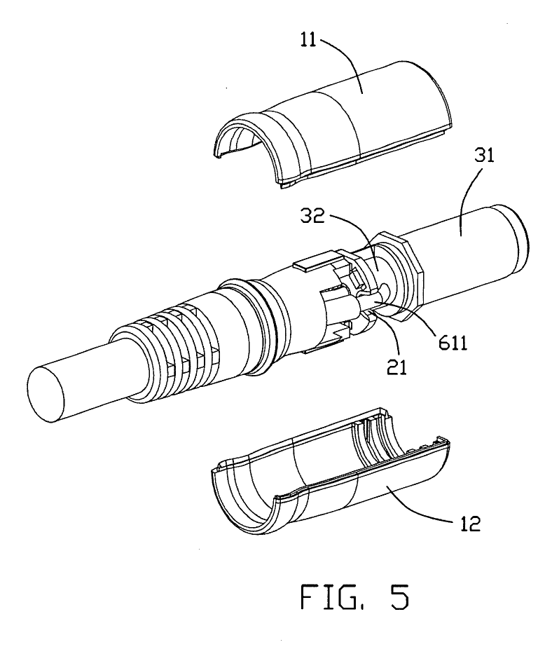

Referring to FIGS. 4-7, in assembling, the cylindrical mating member 3 is electrically connected with the cable 6, the detective contact 631 is accommodated in the through hole 341 of the mating member 3 and inserted into the central hole 23 of the print circuit board 2, the middle wire 63 is soldered to the detective contact 631. The inner conductor 611 of the positive wire 61 is soldered to the first conductive area 21 of the print circuit board 2, and front end of inner conductor 611 is soldered to the positive tube 32 of the mating member 3. The linking portion 311 of the mating member 3 is soldered to the second conductive area 22 of the print circuit board 2, and the inner conductor 621 of the negative wire 62 is soldered to the linking portion 311. A inner cover 7 is fuscous, and over-molded on an electrical conjunction between the detective contact 631 and the middle wire 63. The inner cover 7 is also enclosing the cable 6 partially. The light pipe 4 is closed in insulative shell 1 with the gibbous blocks 422 received in the rectangle groove 14 of the insulative shell 1, and the LED 24 is aligning with the recess 421 and received in it.

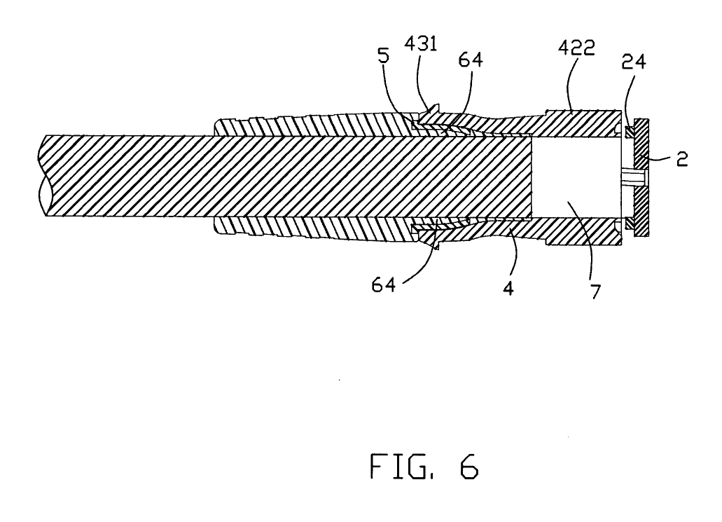

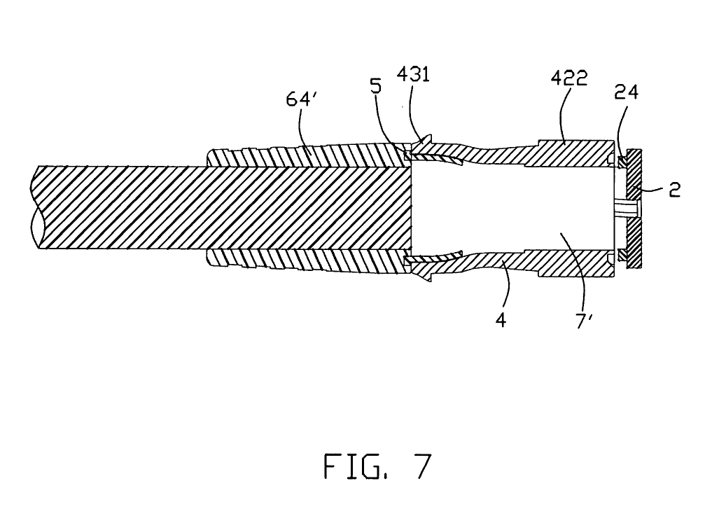

The ring 5 is made of plastic material and in light color, the ring 5 is located in the light pipe 4 and arranged adjacent to the light pipe 4, the ring 5 is located on interior side of the visible area 431 of the light pipe 4 and aligning with the visible area 431. In the first embodiment in accordance with the present invention (shown in FIG. 6), the strain relief portion 64 is darker than the ring 5, when the ring 5 is enclosing the strain relief portion 64 of the cable 6, the ring 5 can avoid the strain relief portion 64 preventing light from the LED 24. In the second embodiment in accordance with the present invention (shown in FIG. 7), the cable assembly is similar to the cable assembly in the first embodiment, only a strain relief portion 64′ and an inner cover 7′ are different from those of the cable assembly 100. When the ring 5 is enclosing the inner cover 7′, the ring 5 is lighter in color than the inner cover 7′ to avoid the inner cover 7′ preventing light from the LED 24. So the indication of the visible area 431 can be insured excellently. Then the top shell 12 is assembled to the bottom shell 11 to close the mating member 3 and other components mentioned formerly, the visible area 431 is exposed out of the insulative shell 1 to indicate the work status of the cable assembly. Thus, the cable assembly 100 is assembled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable assembly, comprising:
a mating member;
a print circuit board;
a LED attached to the print circuit board;
a cable having a positive wire and a negative wire connected with the mating member, and a strain relief portion molded on the wires;
a detective contact connecting with the cable;
a light pipe having a visible area;
an insulative shell enclosing the print circuit board, the cable and the mating member, the visible area exposed out of the insulative shell;
an inner cover over-molded onto a junction between the cable and the detective contact; and
a ring located in the light pipe and neighboring to the light pipe, the ring enclosing at least one of the inner cover and the strain relief portion, and the ring being lighter in color than the inner cover or the strain relief portion.

2. The cable assembly as claimed in claim 1, wherein the ring is located on an interior side of the visible area.

3. The cable assembly as claimed in claim 2, wherein one of the wires is soldered to the print circuit board and the mating member, and another wire is soldered to the mating member directly.

4. The cable assembly as claimed in claim 1, wherein the light pipe defines a cutout in a wall thereof and a pair of protrusions on both sides of the cutout.

5. The cable assembly as claimed in claim 4, wherein the light pipe has a sleeve portion connected with the protrusions, and the visible area is arranged on the end of the sleeve portion to indicate the status of the LED.

6. The cable assembly as claimed in claim 5, wherein the protrusions are perpendicular to the print circuit board.

7. The cable assembly as claimed in claim 6, wherein one of the protrusions has a recess neighboring to the print circuit board, and the recess is aligning with the LED on the print circuit board.

8. The cable assembly as claimed in claim 3, wherein the mating member has a through hole aligning with a central hole of the print circuit board.

9. The cable assembly as claimed in claim 8, wherein the detective contact is received in the through hole of the mating member and has a part extending beyond the print circuit board and inserted into the central hole.

10. The cable assembly as claimed in claim 4, wherein the protrusion defines a gibbous block on an exterior side thereof, and the insulative shell defines a groove receiving the gibbous block.

11. A cable assembly, comprising:
a mating member including a cylindrical housing defining a receiving cavity therein;
a detective pin extending into the receiving cavity, and a power collar disposed on a rear portion of the housing;
a cable having a strain relief portion and a wire connected with the detective pin;
a light pipe with a visible area; and
a ring enclosing the strain relief portion and adjacent to the visible area.

12. The cable assembly of claim 11, further comprises an inner cover molded on an electrical conjunction between the wire and the detective contact.

13. The cable assembly of claim 12, wherein the ring is adjacent to the inner cover on interior side thereof

14. The cable assembly of claim 11, wherein the ring is adjacent to the strain relief on interior side thereof

15. A cable assembly comprising:
a mating member including a cylindrical housing defining a receiving cavity therein;
a detective pin extending into the receiving cavity;
a cable having a strain relief portion and a wire connected with the detective pin;
a light pipe having a visible area through which said cable extends; and
a translucent ring having a portion sandwiched between the strain relief portion and the visible area.

16. The cable assembly as claimed in claim 15, wherein said portion is sandwiched between the strain relief portion and the visible area in an axial direction.

17. The cable assembly as claimed in claim 15, wherein said portion is sandwiched between the strain relief portion and the visible area in a radial direction.
